(19) United States
(12) Patent Application Publication
(10) Pub. No.: US 2026/0225165 A1
(43) Pub. Date: Aug. 6, 2026

(54) Spring-Sleeved Drill Bit Assembly with Integrated Debris Containment

(71) Applicant: Scott Horton, Las Vegas, NV (US)

(72) Inventor: Scott Horton, Las Vegas, NV (US)

(21) Appl. No.: 19/420,619

(22) Filed: Dec. 15, 2025

Related U.S. Application Data
(60) Provisional application No. 63/753,699, filed on Feb. 4, 2025.

(51) Int. Cl. B23B 51/12

(52) U.S. Cl. CPC B23B 51/12

(57) ABSTRACT

A drill bit assembly includes a drill bit, a multi-part body configured to retain the drill bit along a central axis, a sleeve disposed concentrically about at least a portion of the drill bit, and a biasing member positioned between the sleeve and the multi-part body. The sleeve is translationally movable relative to the multi-part body and is urged by the biasing member toward a forward position in which the sleeve extends distally beyond the drill bit's cutting portion. During drilling, the sleeve retracts under applied feed pressure to expose the cutting portion while containing particulate debris within an internal volume of the sleeve. The configuration reduces the risk of debris scatter, enhances operator safety, and maintains worksite cleanliness. The assembly is adaptable to various drill bit geometries and materials, and is compatible with different coupling mechanisms for use in consumer, commercial, and industrial drilling applications.

### BACKGROUND OF THE INVENTION

### Field of Invention

The present disclosure relates to drilling implements and accessories. More particularly, the disclosure pertains to drill bit assemblies incorporating translationally biased protective sleeves configured to capture and contain particulate debris generated during a drilling operation.

### Brief Summary of the Invention

In one aspect, the present disclosure provides a drill bit assembly configured to reduce operator exposure to debris and particulate matter generated during drilling. The drill bit assembly comprises a drill bit, a multi-part body operatively coupled to and retaining the drill bit, and a drill bit sleeve mounted for translational movement relative to the multi-part body. A biasing element, such as a compression spring, is operatively disposed between the multi-part body and the drill bit sleeve, urging the drill bit sleeve toward a forward, distalmost position during use. The sleeve is dimensioned and positioned to receive at least a portion of the drill bit and to capture debris, such as metallic or wooden shavings, produced during drilling.

The spring-biased sleeve operates to contain hot, sharp, or otherwise hazardous particulate matter within the sleeve interior, thereby mitigating the risk of eye or skin injury to the operator and reducing environmental contamination in the work area. The disclosed drill bit assembly is particularly suited for applications involving the preparation of bores for locks, fasteners, and related hardware. Variations in configuration, materials, and dimensional relationships may be implemented without departing from the scope of the inventive concept.

### BRIEF DESCRIPTION OF THE FIGURES

FIG. 1 - FIG. 1 is a photographic side view of a conventional drill bit assembly for fastener installation in an assembled state.

FIG. 2 - FIG. 2 is a photographic side view of the drill bit assembly of FIG. 1 in a disassembled state.

FIG. 3 - FIG. 3 is a photographic side view of a drill bit assembly with a debris-catching spring sleeve in an assembled state.

FIG. 4 - FIG. 4 is a photographic side view of the drill bit assembly of FIG. 3 in a disassembled state.

FIG. 5 - FIG. 5 is a photographic side view of the drill bit assembly of FIG. 3 in an exploded state.

FIG. 6 - FIG. 6 is a schematic side view of the drill bit assembly of FIG. 3.

FIG. 7 - FIG. 7 is a schematic cross-sectional view of the drill bit assembly of FIG. 6.

FIG. 8 - FIG. 8 is a schematic exploded view of the drill bit assembly of FIG. 6.

### DETAILED DESCRIPTION

The present disclosure is directed to a drill bit assembly incorporating an integrated debris containment system, wherein a sleeve element is translationally biased relative to a drill bit-retaining body. In general terms, the assembly is configured to be operatively coupled to a rotary driving device, such as a hand-held or stationary drill, to facilitate the formation of bores within a variety of workpiece substrates. The assembly is further configured to mitigate the emission of particulate matter generated as a byproduct of the drilling process, thereby addressing operator safety concerns and improving worksite cleanliness.

In an exemplary embodiment, the drill bit assembly comprises three principal subsystems: a cutting element in the form of a drill bit; a multi-part structural body configured to secure and align the drill bit along a central rotational axis; and a translationally mounted sleeve element, which is biased toward a forward, distalmost position by a resilient biasing member. The multi-part body provides a rigid coupling between the drill bit and the driving device while allowing for the relative axial movement of the sleeve. The translational movement of the sleeve is constrained along the longitudinal axis of the drill bit and is governed by the compressive and restorative forces of the biasing member, typically embodied as a helical compression spring.

The drill bit is disposed concentrically within the sleeve such that, in a rest state, the forward edge of the sleeve extends distally beyond the primary cutting edges of the drill bit. During operation, as the cutting edges of the drill bit are advanced into the workpiece, the sleeve is urged proximally against the biasing force of the spring, thereby exposing the cutting surfaces to the substrate. Simultaneously, the surrounding sleeve functions as a physical barrier, intercepting debris expelled radially and directing it into the sleeve's internal volume. Upon completion of the drilling operation, the spring restores the sleeve to its forwardmost position, thereby containing accumulated debris within the sleeve interior for subsequent removal.

The disclosed assembly is suitable for use across a wide range of materials, including but not limited to ferrous and non-ferrous metals, natural and engineered woods, and polymeric composites. The debris containment mechanism is particularly advantageous in scenarios involving elevated drilling speeds or high-friction substrate engagement, where particulate matter may become thermally energized, creating potential for ocular or dermal injury. Furthermore, the assembly's geometry and relative component positioning are selected to maintain optimal chip evacuation, minimize clogging, and preserve cutting efficiency, notwithstanding the presence of the debris-containment sleeve.

From a systems perspective, the drill bit assembly is adaptable to varying dimensional specifications, including standard and non-standard shank diameters, bit lengths, and cutting profiles. The multi-part body may be configured to interface with conventional drill chucks, quick-change systems, or specialized industrial holding mechanisms, thereby broadening the applicability of the invention across commercial, industrial, and consumer-grade drilling platforms. This structural adaptability, combined with the integrated debris containment functionality, represents a substantial advancement over conventional drill bit assemblies, which typically lack dedicated safety features for particulate capture and containment.

The drill bit assembly of the present disclosure comprises a plurality of interconnected structural components, each performing a distinct function in furtherance of the debris containment objective, and collectively configured to operate as a unified, rotationally driven tool. In its preferred embodiment, the assembly consists of a cutting member, a multi-part body configured to retain and align the cutting member, a translational sleeve element surrounding at least a portion of the cutting member, and a resilient biasing mechanism disposed between the sleeve and the multi-part body.

The cutting member is embodied as an elongate drill bit, having a proximal shank portion adapted to be received within a chuck or quick-change coupling mechanism of a rotary driving device, and a distal working portion terminating in one or more cutting edges. The working portion may be configured with a conventional twist geometry, a brad-point profile, or a specialized cutting tip suited for particular substrates. Flutes extend helically along the working portion to facilitate chip evacuation and thermal dissipation. In preferred embodiments, the drill bit is fabricated from high-speed steel (HSS) or carbide alloys, optionally with a surface treatment such as titanium nitride (TiN) or diamond-like carbon (DLC) coating to enhance wear resistance and reduce friction.

The multi-part body serves as the primary structural housing to which the drill bit is secured. This body is configured in two or more segments, permitting assembly and disassembly for maintenance or bit replacement. In one embodiment, the multi-part body includes a proximal collar portion, a central guide portion, and a distal retention portion. The proximal collar portion interfaces directly with the driving device and transmits torque to the drill bit. The central guide portion houses bearing surfaces or bushings that maintain concentric alignment between the drill bit and the sleeve. The distal retention portion provides anchoring points for the biasing member and limits the forward travel of the sleeve.

Preferred materials for the multi-part body include hardened tool steels or stainless steel alloys for high-load industrial applications, or high-performance engineering polymers reinforced with glass or carbon fibers for weight reduction in consumer applications. The multi-part configuration allows for component replacement without requiring full disassembly of the assembly from the driving device.

The sleeve is a generally cylindrical component disposed coaxially about the drill bit and dimensioned to permit axial translation relative to the multi-part body. The internal diameter of the sleeve is selected to provide clearance for free rotation of the drill bit without substantial radial play, thereby ensuring effective containment of debris without binding or excessive wear. The sleeve's distal end may be formed with a chamfered or radiused edge to reduce snagging on the workpiece surface. In some embodiments, transparent or semi-transparent polymers, such as polycarbonate or acrylic, may be employed to permit visual observation of the drilling process while maintaining impact resistance.

The sleeve's exterior surface may incorporate texturing, knurling, or polymer overmolding to provide the operator with a secure grip when manually retracting the sleeve for cleaning or inspection. In high-duty industrial versions, the sleeve may be fabricated from heat-treated steel or aluminum alloys with an anodized or hard-coated surface to resist abrasion from high-temperature metal shavings.

The biasing member is operatively disposed between the multi-part body and the sleeve, urging the sleeve toward its forwardmost position under a compressive preload. A helical compression spring is preferred for its compactness, predictability, and linear load-deflection characteristics. The spring may be fabricated from stainless steel, music wire, or corrosion-resistant alloys such as Inconel®, depending on the anticipated environmental exposure. The spring constant is selected to balance two competing operational requirements: (i) sufficient resistance to inadvertent retraction under vibration or minor contact, and (ii) adequate compressibility to allow the sleeve to retract fully during drilling without impeding feed pressure.

All structural components are dimensioned to maintain precise concentricity between the drill bit and the sleeve during high-speed rotation. Tolerances are selected based on anticipated operating speeds and substrate hardness; for example, clearance between the drill bit and sleeve may be maintained within a range of 0.25 mm to 0.50 mm to minimize debris escape while preventing frictional contact.

Manufacturing methods may include CNC machining, precision forging, or injection molding with secondary finishing operations, depending on the component material. Surface finishes on mating components are specified to reduce wear, resist corrosion, and maintain operational smoothness over extended service life.

Collectively, these structural and material considerations ensure that the drill bit assembly is capable of withstanding the mechanical, thermal, and environmental stresses associated with drilling a wide range of materials, while simultaneously providing effective containment of hazardous particulate matter.

In operation, the drill bit assembly disclosed herein functions as a dynamically balanced system wherein rotational cutting, axial feed movement, and translational sleeve displacement are coordinated to produce a borehole while simultaneously containing and isolating particulate debris generated during the drilling process.

In a pre-operational state, the sleeve is urged to its forwardmost, distalmost position by the biasing member, with its distal end extending beyond the cutting edges of the drill bit. The sleeve's position establishes a physical barrier between the cutting region and the surrounding environment, thereby reducing the risk of accidental contact with the cutting edges and mitigating pre-drilling debris dispersal from incidental contact with the workpiece surface.

Upon actuation of the rotary driving device, torque is transmitted from the device's chuck into the proximal shank of the drill bit via the multi-part body. The bit rotates freely within the sleeve interior, with the sleeve itself remaining stationary relative to the workpiece until axial feed pressure is applied.

When the operator advances the drill bit assembly toward the workpiece, the distal end of the sleeve contacts the workpiece surface first. Continued feed pressure causes the sleeve to retract axially against the compressive force of the biasing member, thereby exposing the drill bit's cutting edges to the substrate. The retraction path is strictly linear along the longitudinal axis, with lateral movement constrained by the interface between the sleeve and the multi-part body's guide structures.

The biasing member is dimensioned such that sleeve retraction occurs in a controlled, damped manner, avoiding abrupt displacement that could compromise drilling accuracy or cause the sudden release of debris.

As the drill bit penetrates the workpiece, the flutes of the bit convey chips, shavings, or other particulate matter axially along the bit toward the sleeve's interior cavity. In conventional, unsleeved drill bits, such debris is expelled radially under centrifugal force, creating potential hazards. In the disclosed assembly, the sleeve intercepts such debris within its internal volume, where rotational airflow generated by the bit's flutes directs particulate matter toward the sleeve walls.

The geometry of the sleeve's internal bore and the relative clearance between the sleeve and drill bit are optimized to promote retention of debris through a combination of mechanical obstruction and reduction of radial exit pathways. For metallic substrates, where generated shavings may reach elevated temperatures due to frictional heating, the sleeve functions as a thermal shield, preventing high-energy particles from escaping the immediate drilling zone.

Upon completion of the bore, the operator withdraws the drill bit assembly from the workpiece. The removal of feed pressure allows the biasing member to restore the sleeve to its distalmost position, thereby sealing off the bore opening and fully enclosing any residual debris adhering to the drill bit. This restoration occurs prior to cessation of bit rotation, thereby preventing debris discharge during bit spin-down.

Once rotation ceases, the operator may manually retract the sleeve for debris removal, cleaning, or visual inspection of the bit. In some embodiments, the sleeve is provided with a removable or hinged section to facilitate debris disposal without full disassembly of the drill bit assembly.

The disclosed functional arrangement yields multiple operational advantages over prior-art drill bit configurations. By preventing the uncontrolled ejection of debris, the assembly reduces the risk of ocular injury, skin burns, and inhalation of fine particulate matter. The sleeve also functions as a guard to prevent inadvertent contact with the rotating cutting edges during setup or repositioning.

Additionally, the controlled retraction of the sleeve provides a degree of positional stability, as the sleeve's contact with the workpiece surface can assist in centering the bit at the intended bore location, reducing bit wander and improving bore alignment accuracy. The thermal barrier effect of the sleeve further protects surrounding components or surfaces from incidental heat damage, which is particularly beneficial in precision manufacturing and assembly environments.

The drill bit assembly disclosed herein is susceptible to numerous modifications and variations without departing from the inventive concept. In certain embodiments, the sleeve element may be fabricated in interchangeable lengths or diameters to accommodate drill bits of varying sizes and profiles, thereby allowing a single multi-part body and biasing mechanism to serve a range of applications. In other configurations, the biasing member may be selected from torsion springs, wave springs, or elastomeric compression members, each providing distinct load-deflection characteristics suited for particular operational environments. For example, elastomeric members may offer enhanced vibration damping in portable drilling operations, whereas metallic springs may be preferred for high-cycle industrial use due to their predictable fatigue performance.

The geometry of the sleeve may also be adapted for specialized tasks. In woodworking applications, a flared or funnel-shaped distal opening may be employed to reduce marring of delicate surfaces, while in metalworking, a reinforced distal edge may be provided to withstand repeated contact with hardened substrates. In certain variants, the sleeve may be formed from heat-resistant ceramics or composite laminates to withstand extreme thermal loads without deformation. The inner bore of the sleeve may be treated with low-friction coatings, such as polytetrafluoroethylene (PTFE), to improve chip flow and minimize accumulation of resinous or adhesive debris from composite materials.

Alternative retention and coupling mechanisms between the drill bit and the multi-part body are contemplated. Quick-release collets, magnetic retention devices, or cam-lock interfaces may be substituted for conventional chuck-based mounting to expedite tool changes in production environments. The multi-part body itself may be adapted to incorporate integrated bearings, bushings, or linear guides to further reduce sleeve wobble and extend component life under continuous-duty operation.

For applications involving confined spaces or overhead drilling, the sleeve may be provided with integrated dust ports or vacuum couplings to interface with external debris extraction systems, enhancing containment efficiency and meeting stringent occupational safety regulations. In some embodiments, transparent sleeves with embedded measurement scales or alignment markings may be used to provide visual feedback on drilling depth without compromising the debris barrier. Furthermore, the biasing member's preload and travel distance may be selectively adjustable by the operator, allowing fine-tuning of sleeve responsiveness to match material hardness, feed pressure, and desired chip evacuation characteristics.

The invention is also scalable for non-handheld systems, including robotic drilling stations, CNC machining centers, and automated assembly lines. In such instances, the multi-part body may be adapted for direct integration into machine spindles, with the biasing and sleeve motion controlled by servo actuators in place of purely mechanical springs. Such adaptations extend the utility of the disclosed assembly to high-precision industrial contexts, while retaining the fundamental principle of translational debris containment about a rotating cutting member.

### DETAILED DESCRIPTION OF FIGURES

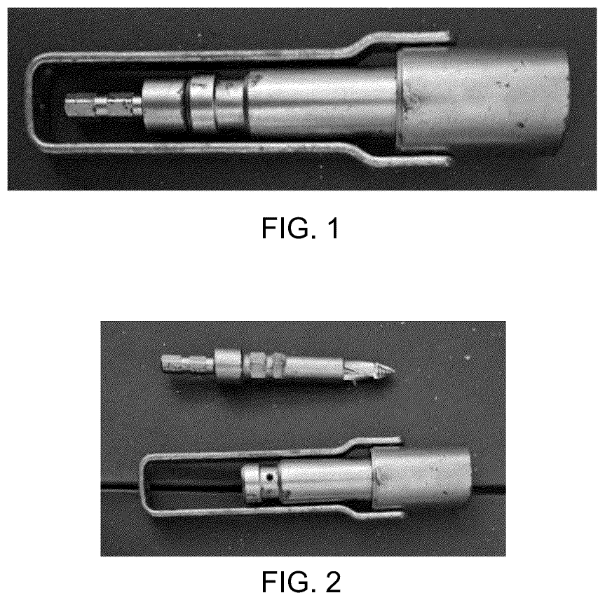

FIG. 1 illustrates a representative example of a conventional drill bit assembly configured for use in fastener installation operations, shown in a fully assembled state. The depicted assembly comprises a drill bit secured within a fixed body that lacks any translational sleeve or integrated debris containment mechanism. As such, during use, debris generated by the cutting action of the bit would be expelled freely in the radial and axial directions, potentially creating hazardous conditions for the operator and nearby surfaces. This figure serves as a baseline for comparison to the improved debris containment features of the present disclosure.

FIG. 2 depicts the conventional drill bit assembly of FIG. 1 in a disassembled configuration, revealing the discrete components comprising the prior-art structure. The figure shows the drill bit separated from its associated retaining body, illustrating the absence of a spring-biased sleeve or any other structure designed to capture or contain debris. The lack of such features in the conventional configuration underscores the susceptibility of the prior art to debris scatter and the associated risks during drilling operations.

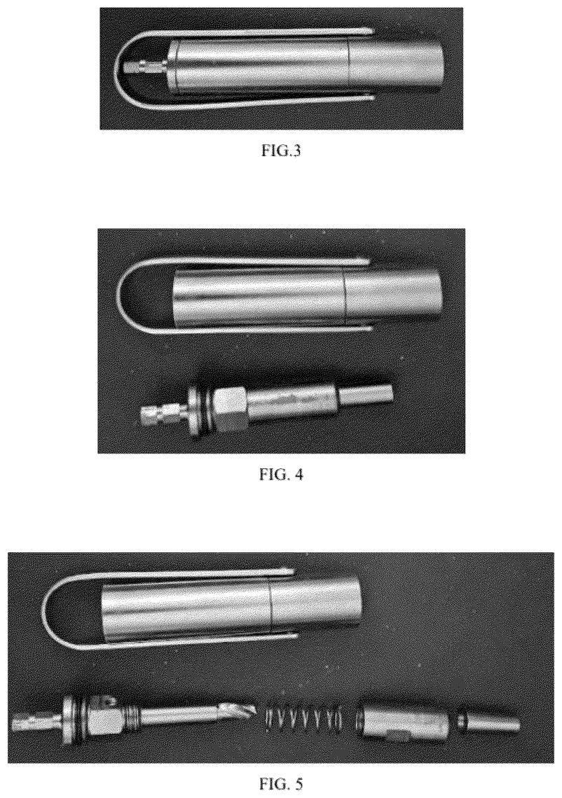

FIG. 3 illustrates an embodiment of the present invention in its fully assembled operational state. A cylindrical sleeve is concentrically disposed about the drill bit, with its distal end extending beyond the cutting tip under the influence of a compression spring positioned between the sleeve and the multi-part body. This forward position provides an immediate barrier to particulate matter generated during drilling. The assembly appears externally as a unified, compact unit compatible with standard rotary driving devices while concealing the internal biasing and guide structures that enable its debris containment function.

FIG. 4 presents the drill bit assembly of FIG. 3 in a disassembled condition, revealing the primary components: the drill bit, the multi-part body, the translational sleeve, and the compression spring. The separation of components demonstrates the modular nature of the assembly, permitting replacement of worn elements or interchange of sleeves of differing dimensions. The relationship between the body's distal retention portion and the proximal end of the sleeve is visible, showing the mechanical interface through which the spring exerts its biasing force.

FIG. 5 provides an exploded photographic view of the assembly components arranged in sequential order of assembly. The drill bit is shown positioned to be inserted into the multi-part body, which contains features for torque transfer and axial alignment. The compression spring is depicted between the multi-part body and the sleeve, with the sleeve shown at the distal end of the sequence. This view illustrates the concentric arrangement of components and highlights how the biasing member is captured in a defined cavity to ensure consistent return of the sleeve to its forwardmost position.

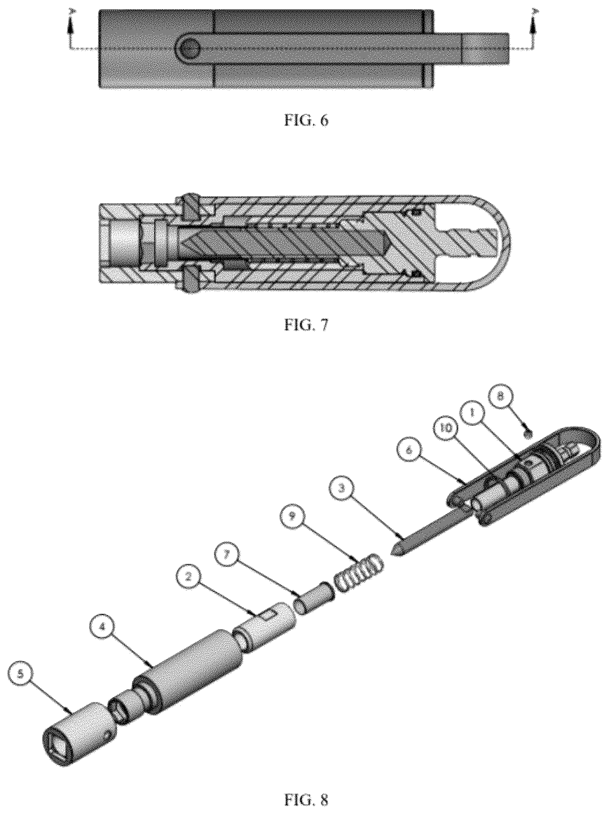

FIG. 6 depicts the assembled drill bit assembly of FIG. 3 in schematic form, offering a side view representation suitable for technical analysis. The sleeve is shown in its distalmost position relative to the drill bit, with section line A-A indicated to define the location of the subsequent cross-sectional view in FIG. 7. This figure allows for a clearer understanding of the general exterior geometry and the spatial positioning of the sleeve relative to the drill bit and multi-part body.

FIG. 7 provides an internal view of the assembly taken along section line A-A of FIG. 6, revealing the coaxial relationship of the drill bit, sleeve, and biasing spring. The cross-section highlights the annular space in which the spring is housed, as well as the guide surfaces that control sleeve motion while maintaining concentricity with the drill bit. This view also illustrates the minimal radial clearance between the drill bit and the sleeve wall, which serves to limit debris escape while permitting free bit rotation.

FIG. 8 depicts the drill bit assembly in exploded schematic form, displaying each major component in its relative position prior to assembly. The figure illustrates the drill bit, multi-part body, sleeve, and biasing spring, along with structural features such as spring seats, bushing receptacles, and sleeve stop surfaces. This schematic emphasizes the precise dimensional relationships and assembly sequence, aiding in the visualization of how the components interact to achieve the debris containment functionality.

What is claimed is:

1. A drill bit assembly, comprising:
a. a drill bit having a proximal shank portion and a distal cutting portion;
a multi-part body configured to retain the drill bit along a central longitudinal axis;
b. a sleeve disposed concentrically about at least a portion of the drill bit and mounted for translational movement relative to the multi-part body along the central longitudinal axis; and
c. a biasing member operatively disposed between the multi-part body and the sleeve, the biasing member urging the sleeve toward a forward, distalmost position in which the sleeve extends beyond the distal cutting portion of the drill bit, d. wherein the sleeve is configured to capture and contain particulate debris generated by the drill bit during drilling of a workpiece.

2. The drill bit assembly of claim 1, wherein the biasing member is a helical compression spring seated within an annular cavity defined between the sleeve and the multi-part body.

3. The drill bit assembly of claim 1, wherein the sleeve comprises an internal bore having a radial clearance relative to the drill bit sufficient to permit free rotation of the drill bit while limiting radial ejection of debris.

4. The drill bit assembly of claim 1, wherein the sleeve is formed from an impact-resistant polymer selected from the group consisting of polycarbonate, acrylic, and reinforced nylon.

5. The drill bit assembly of claim 1, wherein the sleeve is formed from a metal selected from the group consisting of stainless steel, aluminum alloy, and heat-treated steel.

6. The drill bit assembly of claim 1, wherein the multi-part body comprises a proximal collar portion configured to couple to a rotary driving device, a central guide portion to maintain concentricity of the sleeve, and a distal retention portion to limit sleeve travel.

7. The drill bit assembly of claim 1, wherein the sleeve includes a distal edge shaped to reduce snagging on the workpiece surface.

8. The drill bit assembly of claim 1, wherein the biasing member is configured to permit sleeve retraction during application of axial feed pressure while restoring the sleeve to the forward, distalmost position upon release of feed pressure.

9. The drill bit assembly of claim 1, wherein the sleeve is removable and replaceable with sleeves of differing lengths or diameters to accommodate different drill bit sizes.

10. The drill bit assembly of claim 1, wherein the multi-part body is configured for coupling to a quick-change chuck mechanism.

11. The drill bit assembly of claim 1, wherein the sleeve includes an external grip surface to facilitate manual retraction for cleaning or inspection.

12. The drill bit assembly of claim 1, further comprising an integrated dust extraction port formed in the sleeve for connection to an external vacuum system.

13. The drill bit assembly of claim 1, wherein the biasing member is formed from a corrosion-resistant alloy.

14. The drill bit assembly of claim 1, wherein the drill bit includes a coating selected from the group consisting of titanium nitride, diamond-like carbon, and titanium carbonitride.

15. The drill bit assembly of claim 1, wherein the sleeve is at least partially transparent to permit visual observation of the drilling operation.
